(19) United States
(12) Patent Application Publication
(10) Pub. No.: US 2015/0265955 A1
(43) Pub. Date: Sep. 24, 2015

(54) SYSTEM AND METHOD FOR RECYCLING USED OIL

(71) Applicants: Krishna Kanchi, Pittsburgh, PA (US); Thomas Kasun, Export, PA (US); Mark Carr, Alcoa, TN (US)

(72) Inventors: Krishna Kanchi, Pittsburgh, PA (US); Thomas Kasun, Export, PA (US); Mark Carr, Alcoa, TN (US)

(21) Appl. No.: 14/219,502

(22) Filed: Mar. 19, 2014

(51) Int. Cl. B01D 37/03; B01D 17/02; B01D 21/01

(52) U.S. Cl. CPC B01D 37/03; B01D 21/01; B01D 17/02

(57) ABSTRACT

A method, in an embodiment, that includes receiving an oil having particulates and a first turbidity; selecting an agglomeration aid that includes a carboxylic acid; and mixing the oil with a sufficient quantity of the agglomeration aid for a sufficient time at a sufficient temperature so as to result in a product having a second turbidity of at least 25% less than the first turbidity.

### TECHNICAL FIELD

The instant invention relates to methods and systems for recycling used oil.

### BACKGROUND

Methods and systems for treating used oil are known.

### SUMMARY OF INVENTION

In some embodiments, the method includes receiving an oil comprising particulates; wherein the oil has a first turbidity and selecting an agglomeration aid. In some embodiments, the agglomeration aid comprises a dicarboxylic acid having a structure according to formula (I)

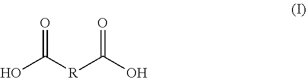

wherein R is selected from the group consisting of an alkane group, an alkene group, an alkyne group, an alkanol group, an aryl group, a hydroxyalkane, a hydroxyalkene, a hydroxyalkyne and a carboxylic acid group, wherein R has about 1 to about 20 carbon atoms.

In some embodiments, the method includes mixing the oil with a sufficient quantity of the agglomeration aid for a sufficient time at a sufficient temperature so as to result in a product having a second turbidity of at least 25% less than the first turbidity. In some embodiments, the agglomeration aid is selected from the group consisting of maleic acid, adipic acid, and combinations thereof. In some embodiments, the method further includes filtering the product.

In some embodiments, the method further includes dissolving the agglomeration aid in a sufficient quantity of water to dissolve the agglomeration aid at 25 degrees Celsius prior to the mixing step. In some embodiments, the method further includes separating the water from the product after the mixing step.

In some embodiments, the method further includes adding a coagulant to the oil, the agglomeration aid, or both. In some embodiments, the coagulant is selected from the group consisting of magnesium sulfate, copper sulfate, ferric sulfate, aluminum sulfite and combinations thereof.

In some embodiments, the method includes receiving an oil comprising particulates and at least one metallic soap; wherein the oil has a first metallic soap weight percent. In some embodiments, the method includes selecting an agglomeration aid, wherein the agglomeration aid comprises a dicarboxylic acid having a structure according to formula (I)

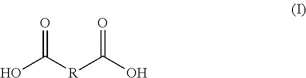

wherein R is selected from the group consisting of an alkane group, an alkene group, an alkyne group, an alkanol group, an aryl group, a hydroxyalkane, a hydroxyalkene, a hydroxyalkyne and a carboxylic acid group, wherein R has about 1 to about 20 carbon atoms.

In some embodiments, the method includes mixing the oil with a sufficient quantity of the agglomeration aid for a sufficient time at a sufficient temperature so as to result in a product having a second metallic soap weight percent of at least 40% less than the first metallic soap weight percent.

In some embodiments, the used oil has a first turbidity and the oil is mixed with a sufficient quantity of the agglomeration aid for a sufficient time at a sufficient temperature so as to result in a product having a second turbidity of at least 25% less than the first turbidity and the second metallic soap weight percent of at least 40% less than the first metallic soap weight percent.

In some embodiments, the method also includes filtering the product.

In some embodiments, the method includes a filtration media used for the filtering step is selected from the group consisting of sand, resin, polyester, polypropylene, nylon, and combinations thereof.

In some embodiments, the agglomeration aid is selected from the group consisting of maleic acid, adipic acid, and combinations thereof. In some embodiments, the method further includes dissolving the agglomeration aid with a sufficient quantity of water to dissolve the agglomeration aid at 25 degrees Celsius prior to the mixing step.

In some embodiments, the method further includes separating the water from the product after the mixing step. In some embodiments, the method includes adding a coagulant to the oil, the agglomeration aid, or both.

In some embodiments, the coagulant is selected from the group consisting of magnesium sulfate, copper sulfate, ferric sulfate, aluminum sulfate and combinations thereof.

In some embodiments, the method includes receiving an oil comprising particulates; wherein the oil has a first turbidity. In some embodiments, the method further includes selecting an agglomeration aid, wherein the agglomeration aid comprises a carboxylic acid. In some embodiments, the method further includes mixing the oil with a sufficient quantity of the agglomeration aid for a sufficient time at a sufficient temperature so as to result in a product having a second turbidity of at least 25% less than the first turbidity.

In some embodiments, the agglomeration aid is selected from the group consisting of maleic acid, citric acid, adipic acid, and combinations thereof. In some embodiments, the method further includes filtering the product.

In some embodiments, the method further includes dissolving the agglomeration aid in a sufficient quantity of water to dissolve the agglomeration aid at 25 degrees Celsius prior to the mixing step.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

FIG. 1 illustrates features of some embodiments of the present invention.

FIG. 2 illustrates features of some embodiments of the present invention.

FIG. 3 illustrates features of some embodiments of the present invention.

FIG. 4 illustrates features of some embodiments of the present invention.

FIG. 5 illustrates features of some embodiments of the present invention.

FIG. 6A illustrates features of a lamella clarifier of an embodiment of the present invention.

FIG. 6B illustrates features of a lamella clarifier of an embodiment of the present invention.

FIG. 7 is a graph showing the particle size distribution of used oil.

The figures constitute a part of this specification and include illustrative embodiments of the present invention and illustrate various objects and features thereof. Further, the figures are not necessarily to scale, some to features may be exaggerated show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

### DETAILED DESCRIPTION

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In some embodiments, the method includes receiving an oil comprising particulates; wherein the oil has a first turbidity and selecting an agglomeration aid. In some embodiments, the agglomeration aid comprises a dicarboxylic acid having a structure according to formula (I)

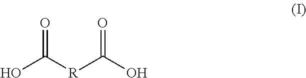

wherein R is selected from the group consisting of an alkane group, an alkene group, an alkyne group, an alkanol group, an aryl group, a hydroxyalkane, a hydroxyalkene, a hydroxyalkyne and a carboxylic acid group, wherein R has about 1 to about 20 carbon atoms.

In some embodiments, the method includes mixing the oil with a sufficient quantity of the agglomeration aid for a sufficient time at a sufficient temperature so as to result in a product having a second turbidity of at least 25% less than the first turbidity. In some embodiments, the agglomeration aid is selected from the group consisting of maleic acid, adipic acid, and combinations thereof. In some embodiments, the method further includes filtering the product.

In some embodiments, the method further includes dissolving the agglomeration aid in a sufficient quantity of water to dissolve the agglomeration aid at 25 degrees Celsius prior to the mixing step. In some embodiments, the method further includes separating the water from the product after the mixing step.

In some embodiments, the method further includes adding a coagulant to the oil, the agglomeration aid, or both. In some embodiments, the coagulant is selected from the group consisting of magnesium sulfate, copper sulfite, ferric sulfate, aluminum sulfate and combinations thereof.

In some embodiments, the method includes receiving an oil comprising particulates and at least one metallic soap; wherein the oil has a first metallic soap weight percent. In some embodiments, the method includes selecting an agglomeration aid, wherein the agglomeration aid comprises a dicarboxylic acid having a structure according to formula (I)

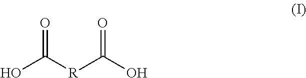

wherein R is selected from the group consisting of an alkane group, an alkene group, an alkyne group, an alkanol group, an aryl group, a hydroxyalkane, a hydroxyalkene, a hydroxyalkyne and a carboxylic acid group, wherein R has about 1 to about 20 carbon atoms.

In some embodiments, the method includes mixing the oil with a sufficient quantity of the agglomeration aid for a sufficient time at a sufficient temperature so as to result in a product having a second metallic soap weight percent of at least 40% less than the first metallic soap weight percent.

In some embodiments, the used oil has a first turbidity and the oil is mixed with a sufficient quantity of the agglomeration aid for a sufficient time at a sufficient temperature so as to result in a product having a second turbidity of at least 25% less than the first turbidity and the second metallic soap weight percent of at least 40% less than the first metallic soap weight percent.

In some embodiments, the method also includes filtering the product.

In some embodiments, the method includes a filtration media used for the filtering step is selected from the group consisting of sand, resin, polyester, polypropylene, nylon, and combinations thereof.

In some embodiments, the agglomeration aid is selected from the group consisting of maleic acid, adipic acid, and combinations thereof. In some embodiments, the method further includes dissolving the agglomeration aid with a sufficient quantity of water to dissolve the agglomeration aid at 25 degrees Celsius prior to the mixing step.

In some embodiments, the method further includes separating the water from the product after the mixing step. In some embodiments, the method includes adding a coagulant to the oil, the agglomeration aid, or both.

In some embodiments, the coagulant is selected from the group consisting of magnesium sulfate, copper sulfate, ferric sulfate, aluminum sulfate and combinations thereof.

In some embodiments, the method includes receiving an oil comprising particulates; wherein the oil has a first turbidity. In some embodiments, the method further includes selecting an agglomeration aid, wherein the agglomeration aid comprises a carboxylic acid. In some embodiments, the method further includes mixing the oil with a sufficient quantity of the agglomeration aid for a sufficient time at a sufficient temperature so as to result in a product having a second turbidity of at least 25% less than the first turbidity.

In some embodiments, the agglomeration aid is selected from the group consisting of nmaleic acid, citric acid, adipic acid, and combinations thereof. In some embodiments, the method further includes filtering the product.

In some embodiments, the method further includes dissolving the agglomeration aid in a sufficient quantity of water to dissolve the agglomeration aid at 25 degrees Celsius prior to the mixing step.

In some embodiments, a method comprises contacting oil with an agglomeration aid, wherein the oil includes particulates and at least one metallic soap, wherein the agglomeration aid is a dicarboxylic acid having a structure according to formula (I)

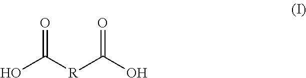

wherein R is selected from the group consisting of an alkane group, an alkene group, an alkyne group, an alkanol group, an aryl group, a hydroxyalkane, a hydroxyalkene, a hydroxyalkyne and a carboxylic acid group, wherein R has about 1 to about 20 carbon atoms, and wherein a sufficient quantity of agglomeration aid contacts the oil so as to result in a reduction in a concentration of the at least one metallic soap in the oil and agglomeration of at least a portion of the particulates in the oil; and filtering the oil and agglomeration aid sufficiently so as to result in a reduction in a concentration of the agglomerated particulates in the oil.

In some embodiments, the agglomeration aid is a carboxylic acid. In some embodiments, the agglomeration aid is a dicarboxylic acid, tricarboxylic acid or other multiple carboxylic acid.

In some embodiments, the carboxylic acid may include Methanoic acid, Ethanoic acid, Propanoic acid, Butanoic acid, Pentanoic acid, Hexanoic acid, Heptanoic acid, Octanoic acid, Nonanoic acid, or higher carbon chain carboxylic acid. In some embodiments, the carboxylic acid may be straight-chain or branched, saturated or unsaturated.

In some embodiments, rolling mill processes includes various uses of oil including, but not limited to, the use of oil as a coolant. In some embodiments, the concentration of contaminants, including, but not limited to, particulates in the oil increases sufficiently so as to diminish the effectiveness of the oil in the rolling mill processes. In some embodiments, the concentrations of metallic soaps including, but not limited to, aluminum and/or iron soaps generated by the saponification of the triglycerides in the oil also increase during the rolling mill process. In some embodiments, the concentration of metallic soaps including, but not limited to, aluminum and/or iron soaps whose formulation is facilitated by the presence of aluminum and/or iron debris together with lubricant components including fatty acids and esters also increase during the rolling mill process. In some embodiments, the increase in the concentrations of metallic soaps in the oil diminishes the effectiveness of the oil in the rolling mill processes. In some embodiments, the oil used in the process having increased concentrations of contaminants and/or metallic soaps is referred to as “used oil”.

“Turbidity” as used herein refers to a measure of the relative clarity of a liquid. The turbidity is measured in Nephelometric Turbidity Units (“NTU”) and determined based on the “turbidity procedure” detailed herein.

In some embodiments, the used oil is cold continuous mill oil. In some embodiments, the used oil is from a vehicle.

In some embodiments, the method includes addition of an agglomeration aid to improve the removal of contaminants from the used oil and/or reduce the metallic soap concentration in the used oil. In some embodiments, the method includes mixture of the agglomeration aid with other filtration media including, but not limited to, sand, glass bead, resin, and/or other media suitable for creating sufficient void space to facilitate contacting of the agglomeration aid with the used oil.

In some embodiments, the method includes mixing the used oil having a first turbidity with a sufficient quantity of the agglomeration aid fir a sufficient time at a sufficient temperature so as to result in a product having a second turbidity of at least 15% less than the first turbidity. In some embodiments, the method includes mixing the used oil having a first turbidity with a sufficient quantity of the agglomeration aid fir a sufficient time at a sufficient temperature so as to result in a product having a second turbidity of at least 20% less than the first turbidity. In some embodiments, the method includes mixing the used oil having a first turbidity with a sufficient quantity of the agglomeration aid for a sufficient time at a sufficient temperature so as to result in a product having a second turbidity of at least 25% less than the first turbidity. In some embodiments, the method includes mixing the used oil having a first turbidity with a sufficient quantity of the agglomeration aid for a sufficient time at a sufficient temperature so as to result in a product having a second turbidity of at least 30% less than the first turbidity. In some embodiments, the method includes mixing the used oil having a first turbidity with a sufficient quantity of the agglomeration aid for a sufficient time at a sufficient temperature so as to result in a product having a second turbidity of at least 35% less than the first turbidity. In some embodiments, the method includes mixing the used oil having a first turbidity with a sufficient quantity of the agglomeration aid fir a sufficient time at a sufficient temperature so as to result in a product having a second turbidity of at least 40% less than the first turbidity. In some embodiments, the method includes mixing the used oil having a first turbidity with a sufficient quantity of the agglomeration aid fir a sufficient time at a sufficient temperature so as to result in a product having a second turbidity of at least 45% less than the first turbidity. In some embodiments, the method includes mixing the used oil having a first turbidity with a sufficient quantity of the agglomeration aid for a sufficient time at a sufficient temperature so as to result in a product having a second turbidity of at least 50% less than the first turbidity. In some embodiments, the method includes mixing the used oil having a first turbidity with a sufficient quantity of the agglomeration aid fir a sufficient time at a sufficient temperature so as to result in a product having a second turbidity of at least 55% less than the first turbidity. In some embodiments, the method includes mixing the used oil having a first turbidity with a sufficient quantity of the agglomeration aid fir a sufficient time at a sufficient temperature so as to result in a product having a second turbidity of at least 60% less than the first turbidity. In some embodiments, the method includes mixing the used oil having a first turbidity with a sufficient quantity of the agglomeration aid for a sufficient time at a sufficient temperature so as to result in a product having a second turbidity of at least 70% less than the first turbidity. In some embodiments, the method includes mixing the used oil having a first turbidity with a sufficient quantity of the agglomeration aid fir a sufficient time at a sufficient temperature so as to result in a product having a second turbidity of at least 80% less than the first turbidity. In some embodiments, the method includes mixing the used oil having a first turbidity with a sufficient quantity of the agglomeration aid for a sufficient time at a sufficient temperature so as to result in a product having a second turbidity of at least 90% less than the first turbidity. In some embodiments, the method includes mixing the used oil having a first turbidity with a sufficient quantity of the agglomeration aid for a sufficient time at a sufficient temperature so as to result in a product having a second turbidity of at least 95% less than the first turbidity. In some embodiments, the method includes mixing the used oil having a first turbidity with a sufficient quantity of the agglomeration aid for a sufficient time at a sufficient temperature so as to result in a product having a second turbidity of at least 97% less than the first turbidity. In some embodiments, the method includes nixing the used oil having a first turbidity with a sufficient quantity of the agglomeration aid for a sufficient time at a sufficient temperature so as to result in a product having a second turbidity of at least 99% less than the first turbidity.

In some embodiments, the method includes mixing the oil with a sufficient quantity of the agglomeration aid for a sufficient time at a sufficient temperature so as to result in a product having a second metallic soap weight percent of at least 10% less than the first metallic soap weight percent. In some embodiments, the method includes mixing the oil with a sufficient quantity of the agglomeration aid for a sufficient time at a sufficient temperature so as to result in a product having a second metallic soap weight percent of at least 20% less than the first metallic soap weight percent. In some embodiments, the method includes mixing the oil with a sufficient quantity of the agglomeration aid for a sufficient time at a sufficient temperature so as to result in a product having a second metallic soap weight percent of at least 30% less than the first metallic soap weight percent. In some embodiments, the method includes mixing the oil with a sufficient quantity of the agglomeration aid for a sufficient time at a sufficient temperature so as to result in a product having a second metallic soap weight percent of at least 40% less than the first metallic soap weight percent. In some embodiments, the method includes mixing the oil with a sufficient quantity of the agglomeration aid for a sufficient time at a sufficient temperature so as to result in a product having a second metallic soap weight percent of at least 50% less than the first metallic soap weight percent. In some embodiments, the method includes mixing the oil with a sufficient quantity of the agglomeration aid for a sufficient time at a sufficient temperature so as to result in a product having a second metallic soap weight percent of at least 60% less than the first metallic soap weight percent. In some embodiments, the method includes mixing the oil with a sufficient quantity of the agglomeration aid for a sufficient time at a sufficient temperature so as to result in a product having a second metallic soap weight percent of at least 70% less than the first metallic soap weight percent. In some embodiments, the method includes mixing the oil with a sufficient quantity of the agglomeration aid for a sufficient time at a sufficient temperature so as to result in a product having a second metallic soap weight percent of at least 80% less than the first metallic soap weight percent. In some embodiments, the method includes mixing the oil with a sufficient quantity of the agglomeration aid for a sufficient time at a sufficient temperature so as to result in a product having a second metallic soap weight percent of at least 90% less than the first metallic soap weight percent. In some embodiments, the method includes mixing the oil with a sufficient quantity of the agglomeration aid for a sufficient time at a sufficient temperature so as to result in a product having a second metallic soap weight percent of at least 95% less than the first metallic soap weight percent. In some embodiments, the method includes mixing the oil with a sufficient quantity of the agglomeration aid for a sufficient time at a sufficient temperature so as to result in a product having a second metallic soap weight percent of at least 97% less than the first metallic soap weight percent. In some embodiments, the method includes mixing the oil with a sufficient quantity of the agglomeration aid for a sufficient time at a sufficient temperature so as to result in a product having a second metallic soap weight percent of at least 99% less than the first metallic soap weight percent.

In some embodiments, the ratio of agglomeration aid to used oil in the mixture ranges from 1:1 to 1:300. In some embodiments, the ratio of agglomeration aid to used oil in the mixture ranges from 1:1 to 1:200. In some embodiments, the ratio of agglomeration aid to used oil in the mixture ranges from 1:1 to 1:150. In some embodiments, the ratio of agglomeration aid to used oil in the mixture ranges from 1:1 to 1:100. In some embodiments, the ratio of agglomeration aid to used oil in the mixture ranges from 1:1 to 1:75. In some embodiments, the ratio of agglomeration aid to used oil in the mixture ranges from 1:1 to 1:50. In some embodiments, the ratio of agglomeration aid to used oil in the mixture ranges from 1:1 to 1:30. In some embodiments, the ratio of agglomeration aid to used oil in the mixture ranges from 1:1 to 1:20. In some embodiments, the ratio of agglomeration aid to used oil in the mixture ranges from 1:1 to 1:10. In some embodiments, the ratio of agglomeration aid to used oil in the mixture ranges from 1:1 to 1:5. In some embodiments, the ratio of agglomeration aid to used oil in the mixture ranges from 1:1 to 1:2.

In some embodiments, the ratio of agglomeration aid to used oil in the mixture ranges from 1:1 to 1:300. In some embodiments, the ratio of agglomeration aid to used oil in the mixture ranges from 1:2 to 1:300. In some embodiments, the ratio of agglomeration aid to used oil in the mixture ranges from 1:5 to 1:300. In some embodiments, the ratio of agglomeration aid to used oil in the mixture ranges from 1:10 to 1:300. In some embodiments, the ratio of agglomeration aid to used oil in the mixture ranges from 1:20 to 1:300. In some embodiments, the ratio of agglomeration aid to used oil in the mixture ranges from 1:30 to 1:300. In some embodiments, the ratio of agglomeration aid to used oil in the mixture ranges from 1:50 to 1:300. In some embodiments, the ratio of agglomeration aid to used oil in the mixture ranges from 1:75 to 1:300. In some embodiments, the ratio of agglomeration aid to used oil in the mixture ranges from 1:100 to 1:300. In some embodiments, the ratio of agglomeration aid to used oil in the mixture ranges from 1:150 to 1:300. In some embodiments, the ratio of agglomeration aid to used oil in the mixture ranges from 1:200 to 1:300.

In some embodiments, the heated oil and/or the agglomeration aid are heated to a temperature ranging from 65 deg. F. to 200 deg. F. In some embodiments, the heated oil and/or the agglomeration aid are heated to a temperature ranging from 85 deg. F. to 200 deg. F. In some embodiments, the heated oil and/or the agglomeration aid are heated to a temperature ranging from 100 deg. F. to 200 deg. F. In some embodiments, the heated oil and/or the agglomeration aid are heated to a temperature ranging from 120 deg. F. to 200 deg. F. In some embodiments, the heated oil and/or the agglomeration aid are heated to a temperature ranging from 135 deg. F. to 200 deg. F. In some embodiments, the heated oil and/or the agglomeration aid are heated to a temperature ranging from 150 deg. F. to 200 deg. F. In some embodiments, the heated oil and/or the agglomeration aid are heated to a temperature ranging from 175 deg. F. to 200 deg. F. In some embodiments, the heated oil and/or the agglomeration aid are heated to a temperature ranging from 185 deg. F. to 200 deg. F.

In some embodiments, the heated oil and/or the agglomeration aid are heated to a temperature ranging from 65 deg. F. to 200 deg F. In some embodiments, the heated oil and/or the agglomeration aid are heated to a temperature ranging from 65 deg F. to 175 deg. F. In some embodiments, the heated oil and/or the agglomeration aid are heated to a temperature ranging from 65 deg. F. to 150 deg. F. In some embodiments, the heated oil and/or the agglomeration aid are heated to a temperature ranging from 65 deg. F. to 135 deg. F. In some embodiments, the heated oil and/or the agglomeration aid are heated to a temperature ranging from 65 deg. F. to 120 deg. F. In some embodiments, the heated oil and/or the agglomeration aid are heated to a temperature ranging from 65 deg. F. to 100 deg. F. In some embodiments, the heated oil and/or the agglomeration aid are heated to a temperature ranging from 65 deg. F. to 85 deg. F.

In some embodiments, the heated oil and the agglomeration aid are mixed for at least 10 seconds. In some embodiments, the heated oil and the agglomeration aid are mixed for at least 30 seconds. In some embodiments, the heated oil and the agglomeration aid are mixed for at least 1 minute. In some embodiments, the heated oil and the agglomeration aid are mixed for at least 2 minutes. In some embodiments, the heated oil and the agglomeration aid are mixed for at least 5 minutes. In some embodiments, the heated oil and the agglomeration aid are mixed for at least 7 minutes. In some embodiments, the heated oil and the agglomeration aid are mixed for at least 10 minutes. In some embodiments, the heated oil and the agglomeration aid are mixed for at least 15 minutes. In some embodiments, the heated oil and the agglomeration aid are mixed for at least 18 minutes. In some embodiments, the heated oil and the agglomeration aid are mixed for at least 20 minutes. In some embodiments, the heated oil and the agglomeration aid are mixed for at least 25 minutes. In some embodiments, the heated oil and the agglomeration aid are mixed for at least 30 minutes. In some embodiments, the heated oil and the agglomeration aid are mixed for at least 40 minutes. In some embodiments, the heated oil and the agglomeration aid are mixed for at least 60 minutes. In some embodiments, the heated oil and the agglomeration aid are mixed for at least 2 hours.

In some embodiments, the particle size of the filtration media is selected to provide sufficient void space to facilitate contacting of the agglomeration aid with the used oil.

In some embodiments, the ratio of agglomeration aid to filtration media in the mixture ranges from 1:5 to 5:1. In some embodiments, the ratio of agglomeration aid to filtration media in the mixture ranges from 1:3 to 3:1. In some embodiments, the ratio of agglomeration aid to filtration media in the mixture ranges from 1:2 to 2:1. In some embodiments, the ratio of agglomeration aid to filtration media in the mixture is 1:1. In some embodiments, the agglomeration aid is used without filtration media.

In some embodiments, the ratio of the agglomeration aid to filtration media in the mixture is based, at least in part, on the particle size of the filtration media.

In some embodiments, the method includes applying the agglomeration aid to filtration media including, but not limited to, bag filters and/or cartridge filters. In some embodiments, the agglomeration aid is added upstream of the filtration device that may include, but is not limited to, sand filter vessel, bag filter assembly, cartridge filter assembly, centrifugal filter, rotary filter, hydrocyclone, and/or other type of filtration device.

In some embodiments, the mixture of the agglomeration aid and the filtration media is added to a pressure vessel. In some embodiments, the used oil flows downward through the mixture of agglomeration aid and the filtration media. In some embodiments, the used oil flows upward through the mixture of agglomeration aid and filtration media. In some embodiments, the used oil flows upward through the mixture of agglomeration aid and filtration media resulting in fluidization of the mixture.

In some embodiments, the agglomeration aid includes, but is not limited to, a dicarboxylic acid having the formula:

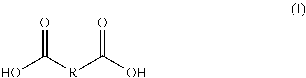

In some embodiments, R is an alkane group, an alkene group, an alkyne group, an alkanol group, an aryl group, a hydroxyalkane, a hydroxyalkene, a hydroxyalkyne and/or a carboxylic acid group. In some embodiments, R may have 1 to about 50 carbon atoms. In some embodiments, R may have about 1 to about 20 carbon atoms. In some embodiments, R may have about 1 to about 10 carbon atoms.

In some embodiments, R is an alkane group that may include, but is not limited to, a methane, ethane, propane, butane, pentane, hexane, heptane, octane, nonane, decane, undecane, dodecane, icosane group or other alkane group.

In some embodiments, R is an alkene group that may include, but is not limited to, ethene, propene, butene, pentene, hexene, heptene, octene, nonene, decene, undecene, dedecene, icosene group or other alkene group.

In some embodiments, R is a hydroxyalkane group including, but not limited to, hydroxymethane, hydroxyethane, hydroxypropane, hydroxybutane, hydroxypentane, hydroxyhexane, or other hydroxyalkane group.

In some embodiments, R may include a functional group that may include, but is not limited to, fluoro, chloro, bromo, iodo, hydroxyl, carbonyl, aldehyde, haloformyl, carbonate ester, carboxylate, carboxyl, ether, ester, hydroperoxy, peroxy, caroxamide, amine, ketimine, aldimine, imide, azide, diimide, cyanate, isocyanate, nitrate, nitrile, nitrosooxy, nitro, nitroso, pydridyl, sulfonyl, sulfo, sulfinyl, sulfino, sulfhydryl, thiocyanate, disulfide, phosphino, phosphono, and phosphate groups.

In some embodiments, R is 2-hydroxypropane-2 carboxylic acid, butane, or ethene.

In some embodiments, the agglomeration aid includes, but is not limited to, citric acid, maleic acid, and/or adipic acid. In some embodiments, the agglomeration aid includes, but is not limited to, a compound configured to reduce the metallic soap concentration in the used oil. In some embodiments, the compound reduces the metallic soap concentration in the used oil by converting the metallic soaps into fatty acids. In some embodiments, the compounds for reducing the metallic soap concentration in the used oil by converting the metallic soaps to fatty acid may include maleic acid and/or citric acid.

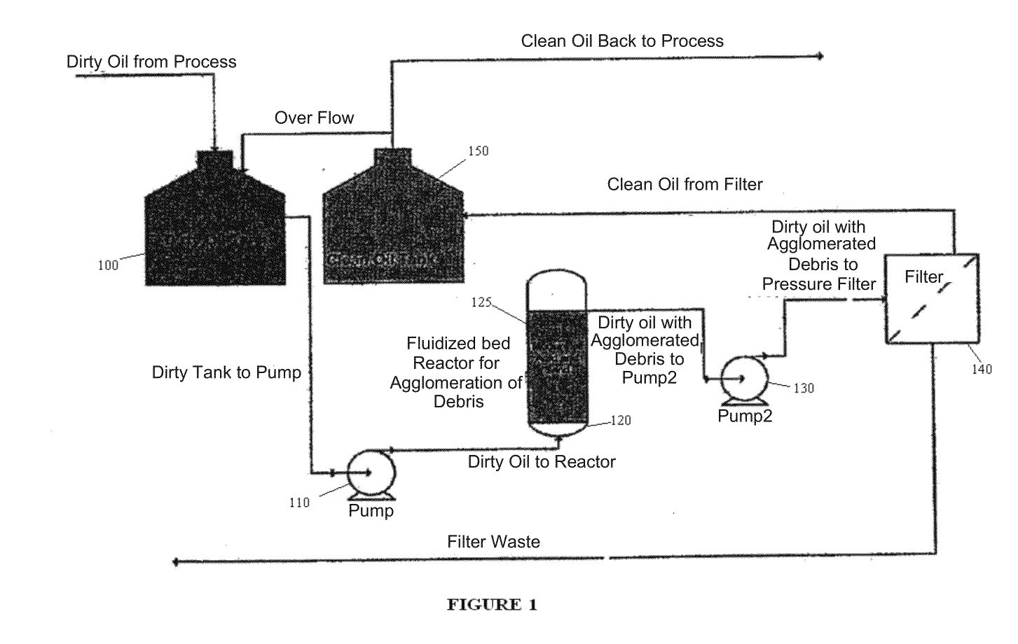

In some embodiments, the method of the present invention is shown on FIG. 1. In some embodiments, the used oil generated from a rolling mill process or other process that results in contamination of oil is stored in a tank 100. In some embodiments, the tank 100 is referred to as “dirty tank”. In some embodiments, the tank 100 is formed of any material compatible with oil including, but not limited to, thermoplastic such as high density polyethylene, metal such as steel or iron, and/or fiberglass.

In some embodiments, the used oil is transferred from tank 100 to a pressure vessel 120 at least partially filled with agglomeration aid using pump 110. In some embodiments, pump 110 is any pump capable of pumping a viscous fluid having elevated concentrations of particulates such as used oil. In some embodiments, the pump 110 may include, but is not limited to, a positive displacement, progressive cavity, rotary gear, centrifugal rotary gear, piston, diaphragm, screw, gear, hydraulic, vane, peristalic, and/or rope pump.

In some embodiments, the used oil is first heated to facilitate pumping and improve overall treatment efficiency. In some embodiments, the oil is heated between 125 deg. F. and 150 deg. F. In some embodiments, the oil is heated between 130 deg. F. and 145 deg. F. In some embodiments, the oil is heated between 131 deg. F. and 142 deg. F. In some embodiments, the heater is not shown on FIG. 1.

In some embodiments, the pressure vessel includes agglomeration aid. In some embodiments, the pressure vessel 120 includes a mixture 125 of agglomeration aid and filter media. In some embodiments, the agglomeration aid is citric acid, maleic acid, and/or adipic acid. In some embodiments, the filter media is sand and/or resin.

In some embodiments, the mixture 125 of the agglomeration aid and filter media form a fluidized bed in the pressure vessel 125 adapted to agglomerate particulates and/or reduce the concentration of other contaminants such as metallic soaps.

In some embodiments, the oil with agglomerated particulates and/or a reduced concentration of other contaminants such as metallic soaps exits the pressure vessel 120. In some embodiments, the oil is stored in a second, interim tank (not shown). In some embodiments, the oil is pumped using pump 130 through a filter 140 to a clean oil tank 150.

In some embodiments, pump 130 is any pump capable of pumping viscous fluid having elevated concentrations of particulates such as used oil. In some embodiments, the pump 130 may include, but is not limited to, a positive displacement, progressive cavity, rotary gear, centrifugal, rotary gear, piston, diaphragm, screw, gear, hydraulic, vane, peristalic, and/or rope pump.

In some embodiments, the filter 140 is adapted to remove agglomerated particulates while allowing flow of the clean oil through the filter. In some embodiments, the filter 140 may include, but is not limited to, a hydrocylcone and/or a rotary filter. In some embodiments, the filter 140 may include, but is not limited to, a cartridge or bag filter.

In some embodiments, the filter 140 may include a Schneider filter, a rotary filter press or other suitable filtration device suitable for removal of solids from oil. A used herein, a “Schneider filter” is a plate-and-frame type filter.

In some embodiments, the oil exiting the filter 140 enters the clean oil tank 150. In some embodiments, the tank 150 is formed of any material compatible with oil including, but not limited to, thermoplastic such as high density polyethylene, metal such as steel or iron, and/or fiberglass. In some embodiments, the oil from the clean oil tank 150 is transferred back for reuse in the rolling mill or equivalent process. In some embodiments, the oil overflowing the clean oil tank 150 is transferred back to the dirty oil tank 100 for retreatment.

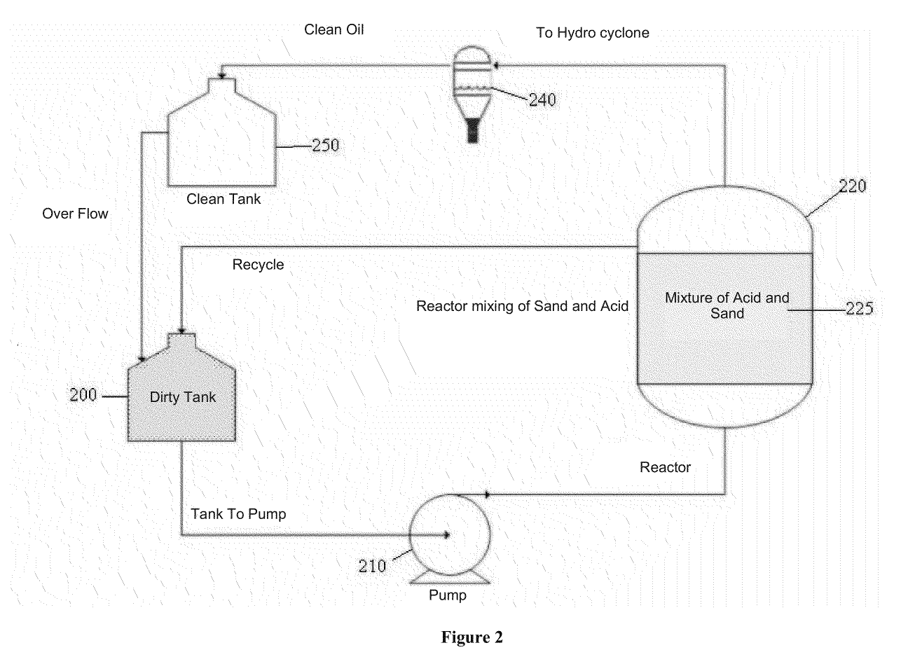

In some embodiments, a representative process flow diagram for the method of the present invention using citric acid is shown as FIG. 2. In some embodiments, the process flow using citric acid includes a dirty tank 200, a pump 210, a pressure vessel 220 having a mixture 225 of agglomeration aid such as citric acid and filter media such as sand and/or resin, a pump (not shown) for transferring the oil through a filter 240 such as a hydrocyclone into a clean tank 250.

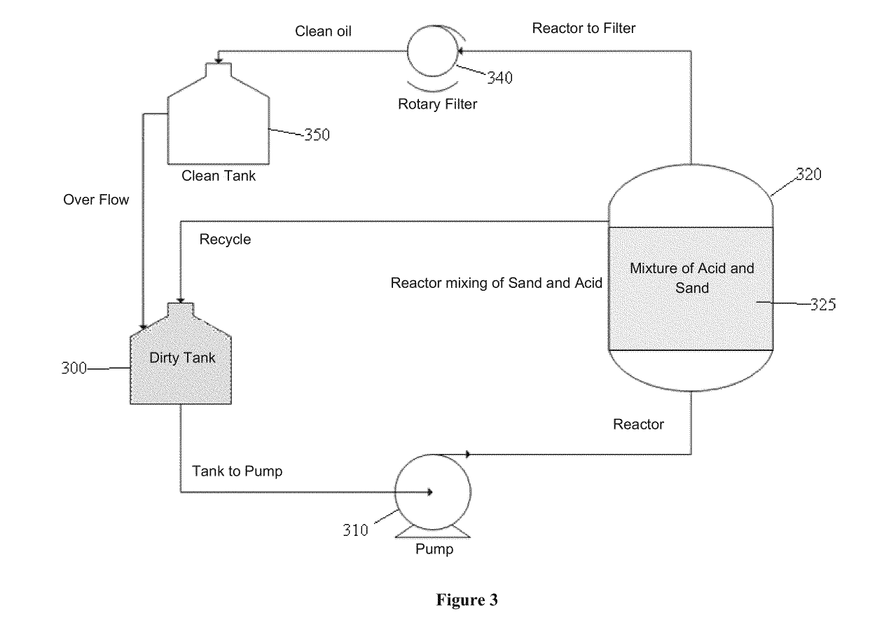

In some embodiments, a representative process flow diagram for the method of the present invention using maleic acid is shown as FIG. 3. In some embodiments, the process flow using maleic acid includes a dirty tank 300, a pump 310, a pressure vessel 320 having a mixture 325 of agglomeration aid such as citric acid and filter media such as sand and/or resin, a pump (not shown) for transferring the oil through a filter 340 such as a rotary filter into a clean tank 350.

In some embodiments, a portion of the used oil is treated according to the method of the present invention and a portion of the used oil is treated using the a filtering aid including, but not limited to, diatomaceous earth (“DE”) wherein the filtering aid is used in combination with a filter unit that nay include, but is not limited to, a Schneider filter [please provide additional detail regarding the Schneider filter, a plate-and-frame filter press, a rotary filter press or other suitable filtration device suitable for removal of solids from oil. In some embodiments, the agglomeration aid may be added with the filtering aid. In some embodiments, citric acid may be added to the DE.

In some embodiments, the agglomeration aid may be dissolved in a solvent to form an agglomeration aid solution prior to or concomitantly with mixing with the used oil. In some embodiments, the agglomeration aid is dissolved in a sufficient quantity of solvent to completely dissolve the agglomeration aid. In some embodiments, the agglomeration aid is dissolved in an excess of solvent. In some embodiments, the solvent is water or alcohol. In some embodiments, the agglomeration aid is a dicarboxylic acid having the formula (I) described above. In some embodiments, the agglomeration aid is maleic acid or citric acid.

In some embodiments, the agglomeration aid is added to the solvent and then mixed for a sufficient time to dissolve the solvent. In some embodiments, the solvent may be heated to increase the solubility of the agglomeration aid in the solvent.

In some embodiments, the pH of the agglomeration aid solution may range from 0.2 to 3. In some embodiments, the pH of the agglomeration aid solution may range from 1 to 2.5. In some embodiments, the pH of the agglomeration aid solution may range from 1 to 1.5. In some embodiments, the pH of the agglomeration aid solution may be 1.35.

In some embodiments, the agglomeration aid solution is nixed with the used oil. In some embodiments, the used oil is preheated prior to mixing with the agglomeration aid solution. In some embodiments, the used oil is preheated to a temperature ranging from 30 to 80 degrees C. In some embodiments, the used oil is preheated to a temperature range from 40 to 70 degrees C. In some embodiments, the used oil is preheated to a temperature of 60 degrees C. In other embodiments, the used oil and agglomeration aid solution are heated after mixing.

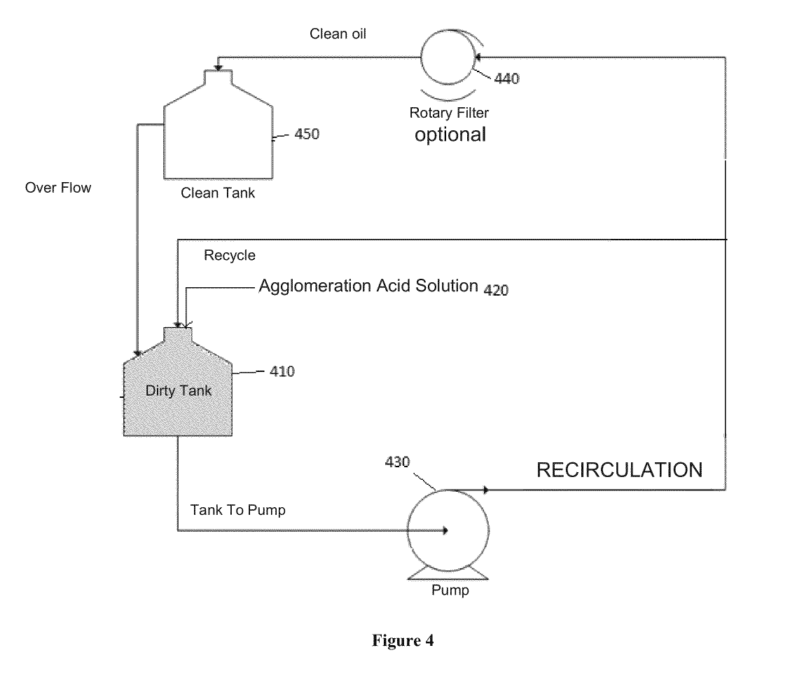

In some embodiments, the agglomeration aid solution is added directly to the “dirty tank” 410 containing used oil as shown on FIG. 4. In some embodiments, the agglomeration aid solution 420 may be mixed with the used oil in the “dirty tank” using a mixer or equivalent. In some embodiments, the agglomeration aid solution may be mixed with the used oil via recirculation using a pump 430 or equivalent as shown in FIG. 4. In some embodiments, the used oil may be pumped through a rotary filter 440 into a clean tank 450.

In some embodiments, the mixing is conducted for 1 to 30 minutes. In some embodiments, the mixing is conducted for 1 to 10 minutes. In some embodiments, the mixing is conducted for 1 to 5 minutes. In some embodiments, the mixing is conducted for 2 minutes.

In some embodiments, a coagulant may be added to the agglomeration aid solution, used oil, or mixture thereof. In some embodiments, the coagulant may include magnesium sulfate, copper sulfite, ferric sulfite, aluminum sulfate, or other suitable compound to facilitate separation of the agglomerated solids from the oil and/or water. In some embodiments, the coagulant may be added directly the agglomeration aid solution and used oil in the dirty tank prior to or concomitantly with mixing.

In some embodiments, the mixed agglomeration aid solution and used oil are separated in the dirty tank into clean oil, agglomerated solids, and water or acidic solution via gravity. In some embodiments, the mixed agglomeration aid solution and used oil settle in the dirty tank for sufficient time to facilitate gravity separation of the clean oil, agglomerated solids, and water or acidic solution. In some embodiments, the mixed agglomeration aid solution and used oil settle for 1 to 48 hours. In some embodiments, the mixed agglomeration aid solution and used oil settle for 1 to 24 hours. In some embodiments, the mixed agglomeration aid solution and used oil settle for 5 to 24 hours. In some embodiments, the mixed agglomeration aid solution and used oil settle for 24 hours.

In some embodiments, the clean oil and agglomerated solids are pumped from the dirty tank through an optional filtration device and into a clean tank as shown on FIG. 4. In some embodiments, the optional filtration device may include, but is not limited to, sand filter vessel, bag filter assembly, cartridge filter assembly, centrifugal filter, rotary filter, hydrocyclone, and/or other type of filtration device. In some embodiments, the clean oil is sufficiently separated from the agglomerated solids and water or acidic solution so as to allow pumping of the clean oil directly the clean oil tank.

In some embodiments, the clean oil, solids, and water or acidic solution are separated in the tank by gravity as described above. In some embodiments, the clean oil is removed from the tank using one or more skimmers or equivalent. In some embodiments, the separated clean oil is extracted using vacuum extraction or equivalent from the dirty tank.

In some embodiments, the agglomeration aid solution and used oil are mixed using a static mixture or equivalent. In some embodiments, the agglomeration aid solution and used oil are mixed using a static mixer designed to handle the acidic, viscous mixture of agglomeration aid solution and used oil. In some embodiments, the static mixture is formed of clear PVC, stainless steel, ductile iron, carbon steel, fiberglass or Kynar.

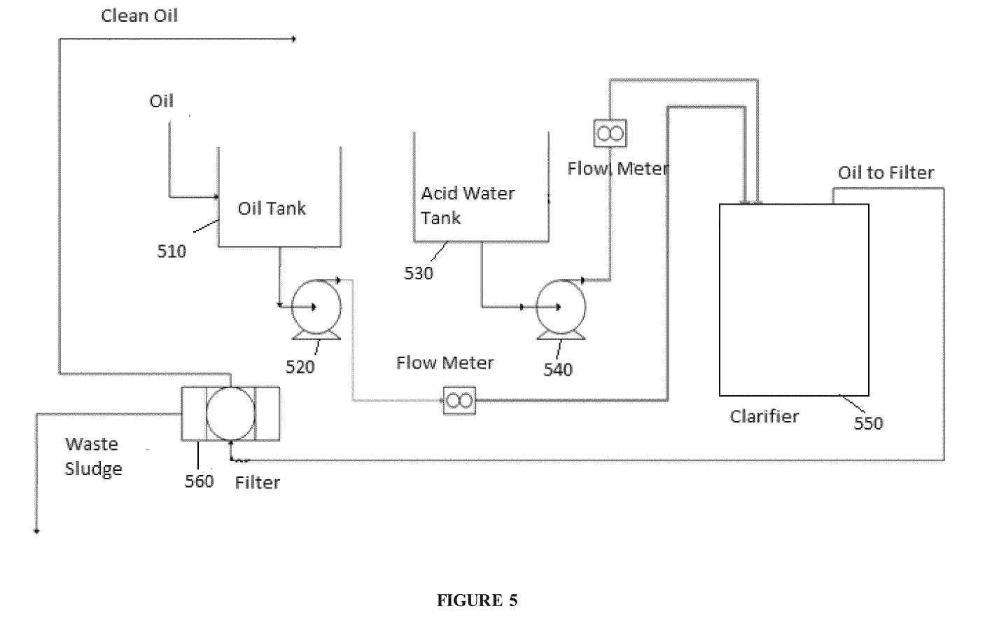

In some embodiments, a representative process flow diagram for the method of the present invention using maleic acid is shown as FIG. 5. In some embodiments, used oil is fed to an oil tank, 510. In some embodiments, the used oil tank includes 300 gallons of oil. In some embodiments, the used oil has a density of 7 pounds per gallon. In some embodiments, the used oil is heated to a temperature of 110 degrees Fahrenheit. In some embodiments, the process includes an acid water tank 530. In some embodiments, the acid water tank holds 30 gallons of water and 50 pounds of maleic anhydride. In some embodiments, the acid/water mixture is heated to a temperature of 110 degrees Fahrenheit. In some embodiments, the used oil is pumped using pump 520 through flow meter into a mix tank (not shown) of a clarifier 550. In some embodiments, the acid water mixtures is pumped using pump 540 to a nix tank (not shown) of a clarifier.

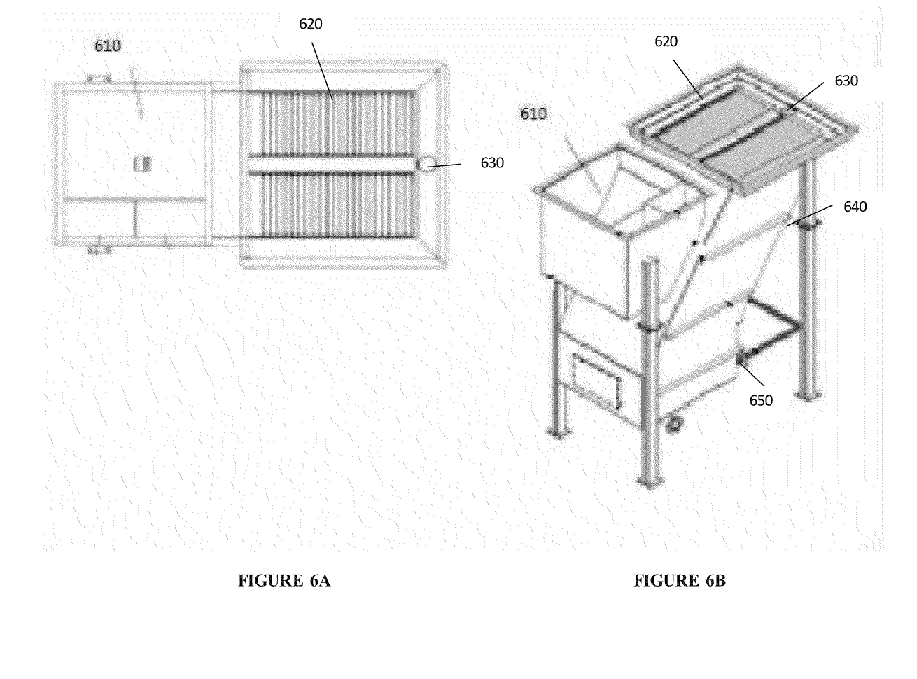

In some embodiments, the clarifier 550 is a lamella or inclined plate-type clarifier as shown in FIGS. 6A and 6B. In some embodiments, the lamella clarifier includes a mix tank (flash/flocc tank) section 610 and a clarification section 620.

In some embodiments, the oil effluent from the clarifier is then transferred via gravity or by pumping to a filter 560 for a polishing filtration step. In the some embodiments, the particulates have been sufficiently removed from the oil to allow for reuse of the clean oil.

### ILLUSTRATIVE EXAMPLES OF THE METHOD OF THE PRESENT INVENTION

Non-limited examples associated with some embodiments of the method of the present invention are detailed below.

### Example 1

In this non-limiting example, used oil first added to an oil tank. A sample of the used oil was then collected (Sample 1). The used oil was heated to a temperature of 110 degrees Fahrenheit and then pumped to the mix tank of the lamella clarifier shown in FIGS. 6A and 6B. An acid/water mixture from a tank containing 30 gallons of water and 50 pounds of maleic anhydride was heated to a temperature of 110 degrees Fahrenheit and then pumped to the nix tank of the lamella clarifier. The ratio of maleic anhydride to used oil in the mix tank was 150. The mixture of oil, water, and maleic anhydride was then mixed for two minutes using an ⅛ horsepower mixer at a maximum mixing speed of 160 RPM.

The mixture from the mix tank was then gravity fed to the clarification section of the lamella clarifier. Samples were then collected from the clarifier effluent 630 (sample 3), the lamella plate section 640 (sample 4) and the bottom portion 650 (sample 5) as illustrated on FIGS. 6A and 6B.

A second oil sample having the same characteristics as the first oil sample was then subjected to the same treatment as the first oil sample except the second oil sample was mixed in the mix tank of the lamella clarifier for 10 minutes. A sample was then collected from the clarifier effluent 630 (sample 6).

The samples were analyzed for metallic soap content (weight percent) using Fourier Transform Infrared Spectroscopy equipment. The samples were analyzed for water content (weight percent) using the standard Karl Fischer titration method. The pH of the samples was determined using a standard pH meter. The samples were also analyzed for total suspended solids using a TSS Portable Hand-held Turbidity, Suspended Solids, and Sludge Level System Hach® Model No. LXV322.99.00002 (“Hach® Level System”). The turbidity of each of the samples was determined using the following turbidity procedure.

Turbidity Procedure

As used herein, the “turbidity” of a sample is determined based on the following procedure:

1) mix 1 milliliter of sample with 15 milliliters of a mixture of 50 weight percent Isopropyl alcohol and 50 weight percent Toluene at 65 degrees Fahrenheit;

2) add 15 milliliters of the mixture to a sample cell having height×width of 2.36 inches×1 inches. The sample cell is formed of borosilicate glass with a screw cap;

3) wipe the sample cell with a soft, lint-free cloth to remove water spots and fingerprints;

4) apply a thin film of silicone oil to the sample cell and wipe with a soft cloth to obtain an even film over the entire surface;

5) turn on the Hach® Level System;

6) insert the filled sample cell in the instrument cell compartment of the Hach® Level System so the diamond or orientation mark aligns with the raised orientation mark in front of the cell compartment and then close the lid of the Hach® Level System.

7) Operate the Hach® Level System to obtain a turbidity reading.

The test results from Example 1 are shown in Table 1.

TABLE 1

| | | | Turbidity | | | | Metallic Soap |
|---|---|---|---|---|---|---|---|
| | | | Reduction | | | | Reduction |
| | | Turbidity | from Sample 1 | Water | | Metallic | from Sample 1 |
| Sample | TSS | (NTU) | (% reduct.) | (wt %) | pH | Soap (wt %) | (% reduct.) |
| 1 | 0.32 | 22.1 | N/A | 0.43 | 3.9 | 2.14 | N/A |
| 2 | 0.28 | 16.5 | 25.3 | 0.50 | 3.6 | 1.28 | 40.2 |
| 3 | 0.26 | 13.5 | 38.9 | 0.36 | 3.6 | 1.07 | 50 |
| 4 | 0.27 | 14.1 | 36.2 | 0.59 | 3.6 | 0.89 | 58.4 |
| 5 | 0.27 | 14.1 | 36.2 | 0.55 | 3.6 | 0.95 | 55.6 |
| 6 | 0 | 0.25 | 98.9 | 0.39 | 3.1 | 0.87 | 59.3 |

### Example 2

In this non-limiting example, used oil was subjected to the same treatment as detailed in Example 1 with 2 minutes of mixing time in the nix tank of the lamella clarifier. Samples of the untreated used oil (sample 7) and the clarifier effluent 630 (sample 8) were collected, filtered using a 20 micron filter, and then tested for turbidity by the turbidity procedure. The test results from Example 2 are shown in Table 2.

TABLE 2

| Sample | Turbidity After Filtering (NTU) |
|---|---|
| 7 | 20.7 |
| 8 | 7.04 |

### Example 3

In this non-limiting example, used oil containing particulates was subjected to various filtration conditions.

In this non-limiting example, a quantity of used oil was passed through a column of varying quantities of maleic acid at varying flow rates. Samples were obtained from the used oil (sample 1), the used oil after treatment with a Schneider filter (sample 2), the used oil after treatment in the column (samples 3-15) and the oil after treatment in the column and a Schneider filter (samples 16 and 17). The samples were then filtered through 20 micron, 10 micron and 5 micron filters. A qualitative evaluation (clean/dirty) of the filtered oil samples was conducted after each filtering step. The unfiltered oil was also tested for metallic soap content (weight percent) and pH using the analytical equipment detailed in Example 1. The test results of Example 3 are shown in Table 3.

| | Flow | Column | | | | Filter | Filter | Filter | Filter | | |
|---|---|---|---|---|---|---|---|---|---|---|---|
| | Rate | height | Maleic | Reside | Wt of | Through | Through | Through | Through | | % |
| | (Index- | (grams | Acid | Time | Bed | Schneider | 20μ | 10μ | 5μ | | Metallic |
| Sample # | ml/min) | of acid) | Conc | (min) | (gms) | (Clean/Dirty) | (Clean/Dirty) | (Clean/Dirty) | (Clean/Dirty) | pH | Soaps |
| 1 | Used | N/A | N/A | N/A | N/A | Not | Dirty | Dirty | Dirty | 4.3 | 2.10% |
| | Oil | | | | | Tested | | | | | |
| 2 | Oil | N/A | N/A | N/A | N/A | Not | Dirty | Dirty | Dirty | 3.9 | 2.10% |
| | (Schneider | | | | | Tested | | | | | |
| | Filter) | | | | | | | | | | |
| 3 | Med | High | Med | 6.5 | 400 | Not | Clean | Clean | Clean | 4.3 | 0.07% |
| | (3-32) | (400 gms) | (50%) | | | Tested | | | | | |
| 4 | High | High | Med | 3.6 | 400 | Not | Clean | Almost | Clean | Not | 0.14% |
| | (5-64) | (400 gms) | (50%) | | | Tested | | Clean | | Tested | |
| 5 | Low | High | Med | 16 | 400 | Not | Clean | Clean | Clean | 4.5 | 0.19% |
| | (2-12.5) | (400 gms) | (50%) | | | Tested | | | | | |
| 6 | High | Med | Med | 3.1 | 300 | Not | Clean | Almost | Clean | Not | 0.11% |
| | (4) | (300 gms) | (50%) | | | Tested | | Clean | | Tested | |
| 7 | Med | High | Low | 7 | 400 | Not | Dirty | Dirty | Partially | 3.3 | 0.55% |
| | (3-32) | (400 gms) | (25%) | | | Tested | | | Dirty | | |
| 8 | Low | Low | Med | 6.5 | 200 | Not | Dirty | Partially | Not | Not | 0.68% |
| | (2-12.5) | (200 gms) | (50%) | | | Tested | | Clean | Tested | Tested | |
| 9 | Med | Med | High | 4.7 | 300 | Not | Dirty | Dirty | Not | Not | 0.70% |
| | (3-32) | (300 gms) | (75%) | | | Tested | | | Tested | Tested | |
| 10 | Low | High | Low | 13 | 400 | Not | Dirty | Dirty | Dirty | 3.3 | 0.77% |
| | (2-12.5) | (400 gms) | (25%) | | | Tested | | | | | |
| 11 | High | Low | Med | 1.8 | 150 | Not | Dirty | Dirty | Dirty | Not | 1.08% |
| | (4) | (150 gms) | (50%) | | | Tested | | | | Tested | |
| 12 | Med | Med | High | 6.5 | 300 | Not | Dirty | Dirty | Not | Not | 1.90% |
| | (3-32) | (300 gms) | (100%) | | | Tested | | | Tested | Tested | |
| 13 | Med | Med | Med | 4.8 | 300 | Not | Dirty | Dirty | Dirty | Not | Not |
| | (3-32) | (300 gms) | (50%) | | | Tested | | | | Tested | Tested |
| 14 | Med | Low | Med | 3.5 | 200 | Not | Dirty | Dirty | Dirty | Not | Not |
| | (3-32) | (200 gms) | (50%) | | | Tested | | | | Tested | Tested |
| 15 | Med | High | 0 | 8 | 400 | Not | Dirty | Dirty | Dirty | Not | Not |
| | (3-32) | (400 gms) | | | | Tested | | | | Tested | Tested |
| 16 | Med | High | Med | 6.4 | 400 | Dirty | Clean | Clean | Clean | Not | 0.23 |
| | (6) | (400 gms) | (50%) | | | | | | | Tested | |
| 17 | Med | High | Med | 12 | 400 | Dirty | Partially | Partially | Partialy | Not | 0.54 |
| | (4) | (400 gms) | (50%) | | | | Clean | Clean | Clean | Tested | |

In addition, 25 grams of the products included Table 4 were added to a beaker with 600 ml of used oil at 60 degrees Celsius. The mixture was then filtered through a Schneider filter for three passes, and samples were collected after each pass. A qualitative evaluation (clean/dirty) of the filtered oil samples was then conducted after each filtering step. The test results are shown in Table 4.

TABLE 4

| Product | Pass 1 | Pass 2 | Pass 3 |
|---|---|---|---|
| Diatomaceous Earth (DE) | Dirty | Dirty | Partially |
| | | | Clean |
| 50% DE + 50% Maleic Acid | Dirty | Dirty (filter paper | Not tested |
| | | clogged) | |
| 75% DE + 25% Maleic Acid | Dirty | Dirty | Dirty |
| 75% DE + 25% Citric Acid | Partially | Partially Clean | Partially |
| | clean | | Clean |

### Example 4

In this non-limiting example, used oil was treated consistent with the process flow shown in FIG. 4. 1000 milliliters of used oil was collected and then heated to 60 degrees Celsius. The used oil was then recirculated through a mixture of sand and either citric acid, maleic acid, or adipic acid for 60 minutes. Samples of the used oil were collected after 30, 45, and/or 60 minutes of recirculation and added to a centrifuge to separate the clean oil from the debris. 5 grams of DE was mixed with clean oil and then pumped through a Schneider filter for a sufficient time to coat the plates. Used oil was then pumped through the coated Schneider filter for 5 minutes. A sample of the used oil/DE mixture was also placed in a centrifuge to separate the clean oil form the debris. Images of the centrifuges were then collected and the turbidity of the mixtures was qualitatively evaluated (i.e., low turbidity or high turbidity). Based on the images, a qualitative evaluation of whether the clean oil was separated from the debris in the centrifuge was conducted. The results of the evaluation are included in Table 5.

TABLE 5

| | | 30 Minutes | | 45 Minutes | | 60 Minutes |
|---|---|---|---|---|---|---|
| | 30 Minutes | Treatment | 45 Minutes | Treatment | 60 Minutes | Treatment |
| | Treatment | Duration | Treatment | Duration | Treatment | Duration |
| Treatment | Duration | (Turbidity) | Duration | (Turbidity) | Duration | (Turbidity) |
| Sand/Citric | No | High | Separation | Low | Separation | Low |
| Acid | Separation | Turbidity | | Turbidity | | Turbidity |
| Sand/Adipic | No | High | Not | Not | Separation | Low |
| Acid | Separation | Turbidity | Tested | Tested | | Turbidity |
| Sand/Maleic | Separated | Low | Not | Not | Separated | Low |
| Acid | | Turbidity | Tested | Tested | | Turbidity |
| DE | Not | Not | Not | Not | Not | Note |
| | Tested | Tested | Tested | Tested | Tested | Tested |

Samples of the untreated and treated oil were also analyzed for metallic soap content (weight percent) using the FTIR equipment identified in Example 1. The test results are shown in Table 6.

TABLE 6

| | | DE/Schneider | | Maleic |
|---|---|---|---|---|
| | Used | Filter | Citric Acid/Sand | Acid/Sand |
| Composition | Oil | Treatment | Treatment | Treatment |
| % Metallic Soap | 2.1 | 2.1 | 0 | 0 |

### Example 5

In this non-limiting example, 50 grams of maleic acid was mixed with a sufficient quantity of water to dissolve the maleic acid. The pH of the acid mixture was then determined using a standard pH meter. All pH results in this example were obtained using a standard pH meter. 200 milliliters of used oil was then heated to 60 degrees Celsius. A sample of the oil was collected, mixed with deionized water and an “oil” pH was determined. The acid mixture was then added to the heated used oil and stirred for 30 minutes at 450 revolutions per minute (RPM). The stirred product was then separated in three products (A, B, and C) of approximately equal volume. Products A and B were added to a centrifuge and treated for 30 minutes. Product C was placed in a separatory funnel and allowed to settle overnight. All three products separated into an oil phase and water phase. The pH of the water phase of each of the products was then determined.

The oil phase of products A and C were then mixed with deionized water and an “oil” pH was determined. Magnesium sulfate was added in ½ gram increments to Product B until the magnesium sulfate particles floated. Product B was then added to centrifuge and treated for 30 minutes. The magnesium sulfate was then separated from Product B. The oil phase of Product B was mixed with deionized water and an “oil” pH was determined. The pH results are shown in Table 7.

TABLE 7

| Product | pH |
|---|---|
| 50 g acid in 70 mL water | 1.35 |
| Used oil | 3.25 |
| A Water | 0.63 |
| A Oil | 2.03 |
| B Water | 0.76 |
| B Oil | 2.22 |
| C Water | 0.23 |
| C Oil | 1.93 |

25 grams of maleic acid was mixed with a sufficient quantity of water to dissolve the maleic acid to form a first acid mixture. 25 grams of maleic acid was then mixed with about double the volume of water required to dissolve the maleic acid to form a second acid mixture. The pH of the acid/water mixture was then determined. Two batches of 300 milliliters of used oil was provided and an image of the used oil was taken. The oil was then heated to 60 degrees Celsius.

The first acid mixture was then added to the first batch of used oil to form Product D. The second acid mixture was then added to the second batch of used oil to form Product E. Products D and E were then stirred for 15 minutes at 60 degrees Celsius. Both products were then transferred to a separatory funnel and allowed to cool to room temperature and separate into oil and water phases. An image of each of the products was then collected and the turbidity of each product was qualitatively evaluated (i.e., low turbidity or high turbidity. The pH of water phase of Products D and E were determined. The oil phases of Products D and E were mixed with deionized water and an “oil” pH was collected. The pH results are shown in Table 8. The turbidity results are shown in Table 9.

TABLE 8

| Product | pH |
|---|---|
| 25 g acid in 35 mL water | Not Tested |
| 25 g acid in 70 mL water | Not Tested |
| Used Oil | 3.25 |
| D Water | 0.53 |
| D Oil | 2.27 |
| E Water | 0.58 |
| E Oil | 2.43 |

TABLE 9

| Product | Turbidity |
|---|---|
| Used Oil | High Turbidity |
| D | Low Turbidity |
| E | Low Turbidity |

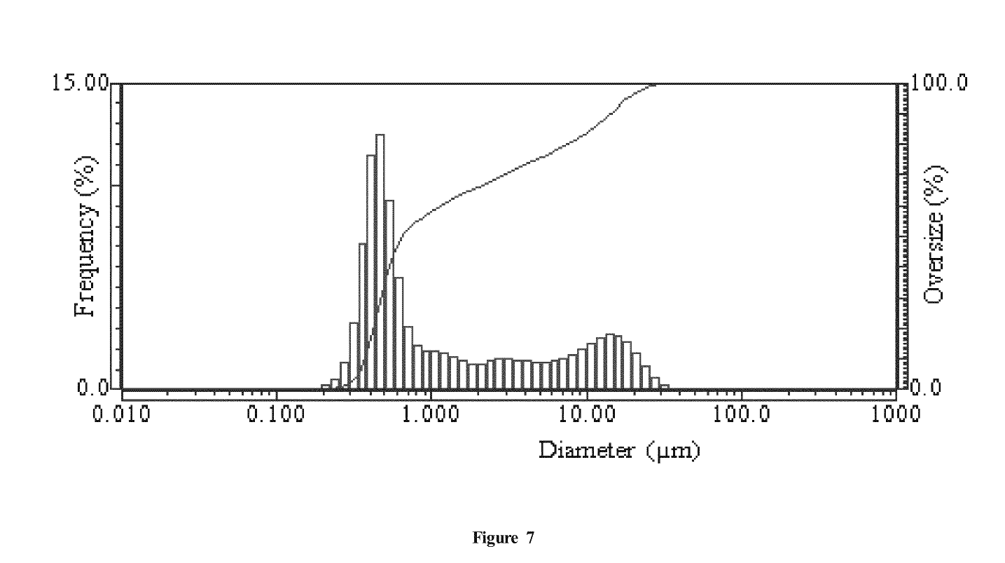

A particle size distribution of the used oil used in the various examples was conducted using a Horiba® particle size distribution analyzer Model No. LA-920. The results of the particle size distribution analysis of the used oil is shown in FIG. 7.

While a number of embodiments of the present invention have been described, it is understood that these embodiments are illustrative only, and not restrictive, and that many modifications may become apparent to those of ordinary skill in the art. Further still the various steps may be carried out in any desired order (and any desired steps may be added and/or any desired steps may be eliminated).

1. A method comprising:
receiving an oil comprising particulates;
wherein the oil has a first turbidity;
selecting an agglomeration aid,
wherein the agglomeration aid comprises a dicarboxylic acid having a structure according to formula (I) 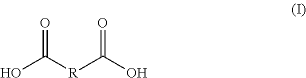
wherein R is selected from the group consisting of an alkane group, an alene group, an alkyne group, an alkanol group, an aryl group, a hydroxyalkane, a hydroxyalkene, a hydroxyalkyne and a carboxylic acid group, wherein R has about 1 to about 20 carbon atoms;
mixing the oil with a sufficient quantity of the agglomeration aid for a sufficient time at a sufficient temperature so as to result in a product having a second turbidity of at least 25% less than the first turbidity.

2. The method of claim 1, wherein the agglomeration aid is selected from the group consisting of maleic acid, adipic acid, and combinations thereof.

3. The method of claim 1, further comprising:
filtering the product.

4. The method of claim 1, further comprising:
dissolving the agglomeration aid in a sufficient quantity of water to dissolve the agglomeration aid at 25 degrees Celsius prior to the mixing step.

5. The method of claim 4, further comprising:
separating the water from the product after the mixing step.

6. The method of claim 1, further comprising:
adding a coagulant to the oil, the agglomeration aid, or both.

7. The method of claim 6, wherein the coagulant is selected from the group consisting of magnesium sulfate, copper sulfate, ferric sulfate, aluminum sulfate and combinations thereof.

8. A method comprising:
receiving an oil comprising particulates and at least one metallic soap;
wherein the oil has a first metallic soap weight percent;
selecting an agglomeration aid,
wherein the agglomeration aid comprises a dicarboxylic acid having a structure according to formula (I) 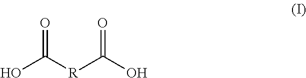
wherein R is selected from the group consisting of an alkane group, an alkene group, an alkyne group, an alkanol group, an aryl group, a hydroxyalkane, a hydroxyalkene, a hydroxyalkyne and a carboxylic acid group, wherein R has about 1 to about 20 carbon atoms;
mixing the oil with a sufficient quantity of the agglomeration aid for a sufficient time at a sufficient temperature so as to result in a product having a second metallic soap weight percent of at least 40% less than the first metallic soap weight percent.

9. The method of claim 8, wherein the used oil has a first turbidity and
wherein the oil is mixed with a sufficient quantity of the agglomeration aid for a sufficient time at a sufficient temperature so as to result in a product having a second turbidity of at least 25% less than the first turbidity and the second metallic soap weight percent of at least 40% less than the first metallic soap weight percent.

10. The method of claim 8, further comprising:
filtering the product.

11. The method of claim 10, wherein a filtration media used for the filtering step is selected from the group consisting of sand, resin, polyester, polypropylene, nylon, and combinations thereof.

12. The method of claim 8, wherein the agglomeration aid is selected from the group consisting of maleic acid, adipic acid, and combinations thereof.

13. The method of claim 8, further comprising:
dissolving the agglomeration aid with a sufficient quantity of water to dissolve the agglomeration aid at 25 degrees Celsius prior to the mixing step.

14. The method of claim 13, further comprising:
separating the water from the product after the mixing step.

15. The method of claim 8, further comprising:
adding a coagulant to the oil, the agglomeration aid, or both.

16. The method of claim 15, wherein the coagulant is selected from the group consisting of magnesium sulfate, copper sulfate, ferric sulfate, aluminum sulfate and combinations thereof.

17. A method comprising:
receiving an oil comprising particulates;
wherein the oil has a first turbidity;
selecting an agglomeration aid,
wherein the agglomeration aid comprises a carboxylic acid mixing the oil with a sufficient quantity of the agglomeration aid for a sufficient time at a sufficient temperature so as to result in a product having a second turbidity of at least 25% less than the first turbidity.

18. The method of claim 17, wherein the agglomeration aid is selected from the group consisting of maleic acid, citric acid, adipic acid, and combinations thereof.

19. The method of claim 17, further comprising:
filtering the product.

20. The method of claim 17, further comprising:
dissolving the agglomeration aid in a sufficient quantity of water to dissolve the agglomeration aid at 25 degrees Celsius prior to the mixing step.
